(19) United States
(12) Patent Application Publication
(10) Pub. No.: US 2010/0050550 A1
(43) Pub. Date: Mar. 4, 2010

(54) ARTICLE OF MANUFACTURE AND SYSTEM FOR STABILIZING CROWN MOLDING

(76) Inventor: SAMUEL ESTOK, Panama City, FL (US)

Correspondence Address: James Ray & Associates, 2640 Pitcairn Road, Monroeville, PA, 15146, US

(21) Appl. No.: 12/553,169

(22) Filed: Sep. 3, 2009

Related U.S. Application Data
(60) Provisional application No. 61/093,867, filed on Sep. 3, 2008.

(51) Int. Cl. E04F 13/21; G09F 7/00

(52) U.S. Cl. 52/288.1; 52/105

(57) ABSTRACT

A decorative trimming system includes at least one substantially straight length of decorative crown molding installed along a ceiling and wall junction and at least one stabilizing member secured between the rear surface of the crown molding and the ceiling and wall junction. The stabilizing member includes a predetermined length and a predetermined shape in a direction transverse to the predetermined length. The predetermined shape is defined by a pair of side edge surfaces extending the length of the stabilizing member and a substantially smooth uninterrupted front surface extending the length of the stabilizing member, abutting rear surface of the crown molding and preferably adjoining each of the pair of side edge surfaces. Arrows and text indicia may be also provided for communicating orientation of the stabilizing member during securement to the ceiling and wall junction as well as during mitering ends of the decorative molding on a miter saw.

### CROSS-REFERENCE TO RELATED APPLICATIONS

This application is related to and claims priority from Provisional Patent Application Ser. No. 61/093,867 filed on Sep. 3, 2008.

### FIELD OF THE INVENTION

The present invention relates, in general, to decorative trim such as crown molding and, more particularly, this invention relates to an article of manufacture and system for stabilizing crown molding during installation and end mitering operation.

### STATEMENT REGARDING FEDERALLY SPONSORED RESEARCH AND DEVELOPMENT

N/A

### REFERENCE TO SEQUENCE LISTING, A TABLE, OR A COMPUTER PROGRAM LISTING COMPACT DISC APPENDIX

N/A

### BACKGROUND OF THE INVENTION

As is generally well known, decorative trim, such as crown molding, is commonly manufactured with two edge surface that are disposed generally perpendicular to each and with a rear smooth surface that extends at a first angle relative to one edge surface and at second angle relative to the other edge surface. As the result, the crown molding is installed with such rear surface being disposed at the different angles relative to respective ceiling and wall surfaces. Generally, prior to the fastening, the crown molding is oriented along the junction of ceiling and wall surfaces so that the side edge having the larger angle is abutting the wall surface and is pointing downwardly relative to the ceiling surface. However, in order to miter cut edges of the crown molding for installation around inside and outside corners of the room, the crown molding needs to be oriented on the miter saw so that the side edge having the larger angle is pointing upwardly. Such contradiction in orientation between fastening and cutting positions has been found to pose difficulties even experienced carpenters tasked with installing crown molding.

Prior to the conception and development of the present invention, efforts have been made to alleviate difficulties with installing and mitering crown molding.

U.S. Pat. No. 5,179,811 issued to Walker et al. discloses a decorative trimming system for installing crown mold, baseboard and the like to a room that includes elongated mounting brackets adapted to be secured along room walls extending about the room periphery. Each bracket includes a projecting tongue that extends along the length of the bracket. Prefabricated corner pieces of molding are provided with longitudinal grooves extending along the back sides of their legs for receiving the tongues of the mounting brackets in snug fitting relationship. Similarly, straight lengths or strips of molding have grooves formed along their back sides also for receiving the tongues of the mounting brackets. In use, mounting brackets are secured along room walls extending about the room periphery and prefabricated corner pieces are pressed or snapped into position on the mounting brackets. Straight lengths of molding are cut and pressed into place between the ends of opposed corner pieces to finish out the trimming without the need for intricate mitering, coping, or other skills not usually possessed by the average homeowner or do-it-yourselfer.

U.S. Pub. No. 2003/0115813 to de Raucourt discloses a plaster crown molding tile and a base support foundation beam that provide mating nesting surfaces such that with the beam mounted to a wall surface, the tile may be placed securely onto the beam. A space is provided for a lighting fixture between the beam and the tile. Preferably, the nesting surfaces comprise orthogonal surfaces.

U.S. Pub. No. 2008/0172964 to Hahn discloses an installation bracket system for use in combination with a length of crown molding for securing the crown molding adjacent to the junction of a wall surface and a ceiling surface, the installation bracket system including one or more installation brackets, each of the one or more installation brackets having first support member and a second support member, each of the support members having a mounting portion and an integrally formed stabilizing portion, the mounting portion having a base formed with apertures to receive fasteners therethrough for securement of the first support member and the second support member to the wall surface and ceiling surface, respectively, and a backing member extending between the first support member and the second support member, the backing member having a front surface, the crown molding being secured against the front surface of the backing member.

Finally, U.S. Pat. No. 4,743,004 to Kloss teaches a jig for coping crown molding that includes a base with a pair of right-angled isosceles triangular support blocks mounted on dowels to the base and with their faces that are at a 45.degree. incline to the base normally facing forward on the base. In one embodiment, the base has a rod which mounts one or more clamps. The clamps hold a length of crown molding with one of its flat rear surfaces resting on the base and with its inclined flat rear surface against the inclined faces of the support blocks. An end of the crown molding piece projects beyond the base where it is accessible for hand coping. The proper shape of the end of the crown molding for corner junctions can then be achieved using wholly vertical saw strokes. In another embodiment, the crown molding is held against the inclined surfaces of the support blocks by an abutment that is adjustably positioned on the base and spaced from the support blocks. The support blocks are reversible to present an upright face towards the front of the base for holding other types of molding and workpieces.

While the above prior art system are suitable for their intended use, there is a continuing need for a decorative trimming system that is inexpensive to manufacture and quick and simple to install.

### SUMMARY OF THE INVENTION

The invention provides a decorative trim system that includes at least one substantially straight length of a decorative crown molding having each of a first edge surface abuttingly engageable with one of a ceiling surface and a wall surface, a second edge surface abuttingly engageable with an opposed one of the ceiling and wall surfaces, the second edge surface disposed generally perpendicular to the first edge surface, a front surface and a rear surface, the rear surface extending at a first angle to one of the first and second edge surfaces and extending at a second angle to an opposed one of the first and second edge surfaces. The decorative trim system also includes at least one article of manufacture for stabilizing the crown molding. The article of manufacture includes a predetermined length alignable along the junction of the wall and ceiling surfaces and a predetermined cross-sectional shape in a direction transverse to the predetermined length. The predetermined cross-sectional shape is defined by a first surface reference portion extending the predetermined length and abuttingly engageable with the one of the ceiling and wall surfaces. There is also a second surface reference portion extending the predetermined length and abuttingly engageable with the opposed one of the ceiling and wall surfaces, the second surface reference portion disposed in a plane being generally perpendicular to a plane of the first surface reference portion. Also provided is a third surface reference portion extending the predetermined length and abuttingly adjoining each of the first and second surface reference portions, the third surface reference portion disposed at the first angle to the first surface reference portion and disposed at the second angle to the second surface reference portion, the third surface reference portion abuttingly engageable with the rear surface of the at least one substantially straight length of decorative crown molding secured along the junction of the ceiling and wall surfaces. Each of the first, second and third surface reference portion is preferably a smooth surface. Finally, the article of manufacture includes means for orienting position of the first and second edge surfaces of the at least one substantially straight length of decorative crown molding.

### OBJECTS OF THE INVENTION

It is, therefore, one of the primary objects of the present invention to provide an article of manufacture for stabilizing crown molding during installation and end mitering operation.

Another object of the present invention is to provide an article of manufacture for stabilizing crown molding during installation and end mitering operation that is inexpensive to manufacture.

Yet another object of the present invention is to provide an article of manufacture for stabilizing crown molding that is simple to install.

A further object of the present invention is to provide an article of manufacture for stabilizing crown molding during installation and end mitering operation that includes orientation markings for properly positioning such article of manufacture for fastening or mitering operation.

Yet a further object of the present invention is to provide an article of manufacture for stabilizing crown molding during installation and end mitering operation that is suitable for use with conventional crown moldings.

An additional object of the present invention is to provide a system for stabilizing crown molding during installation that incorporates the aforedescribed article of manufacture.

In addition to the several objects and advantages of the present invention which have been described with some degree of specificity above, various other objects and advantages of the invention will become more readily apparent to those persons who are skilled in the relevant art, particularly, when such description is taken in conjunction with the attached drawing Figures and with the appended claims.

### BRIEF DESCRIPTION OF THE DRAWINGS

FIG. 1 is an end view of an article of manufacture for stabilizing crown molding during installation and end trimming operation which is constructed in accordance with one embodiment of the present invention;

FIG. 2; illustrates a decorative crown molding system employing the article of FIG. 1;

FIG. 3 is a front perspective view illustrating use of the article of FIG. 1 for mitering an end of the crown molding;

FIG. 4 is a perspective view of the article of FIG. 1, particularly illustrating means for orienting such article during installation of the crown molding;

FIG. 5 is an environmental view illustrating crown molding installed at the junction of the ceiling and wall surfaces; and

FIG. 6 is an end view of an article of manufacture for stabilizing crown molding during installation and end trimming operation which is constructed in accordance with another embodiment of the present invention.

### BRIEF DESCRIPTION OF THE VARIOUS EMBODIMENTS OF THE INVENTION

Prior to proceeding to the more detailed description of the present invention, it should be noted that, for the sake of clarity and understanding, identical components which have identical functions have been identified with identical reference numerals throughout the several views illustrated in the drawing figures.

The present invention describes an article of manufacture and system for stabilizing crown molding during at least one of installation of the decorative crown molding along a junction of a wall surface and a ceiling surface and mitering of at least one end of the decorative crown molding.

The present invention is illustrated and described in combination with at least one substantially straight length of a decorative crown molding 10 having each of a substantially straight length, a first edge surface 12 abuttingly engageable with one of a ceiling surface 4 and a wall surface 6, a second edge surface 14 abuttingly engageable with an opposed one of the ceiling and wall surfaces, 4 and 6 respectively, and disposed generally perpendicular to the first edge surface 12, a front surface 16 and a rear substantially smooth surface 18 extending at a first angle to one of the pair of edge surfaces, referenced as 12 in various figures and extending at a second angle to an opposed one of the pair of edge surfaces, referenced as 14 in various figures, although it will be apparent to those skilled in the relevant art that the present invention may be applied to other decorative molding types and as such should not be interpreted as a limiting factor of the crown molding stabilizing system of the present invention.

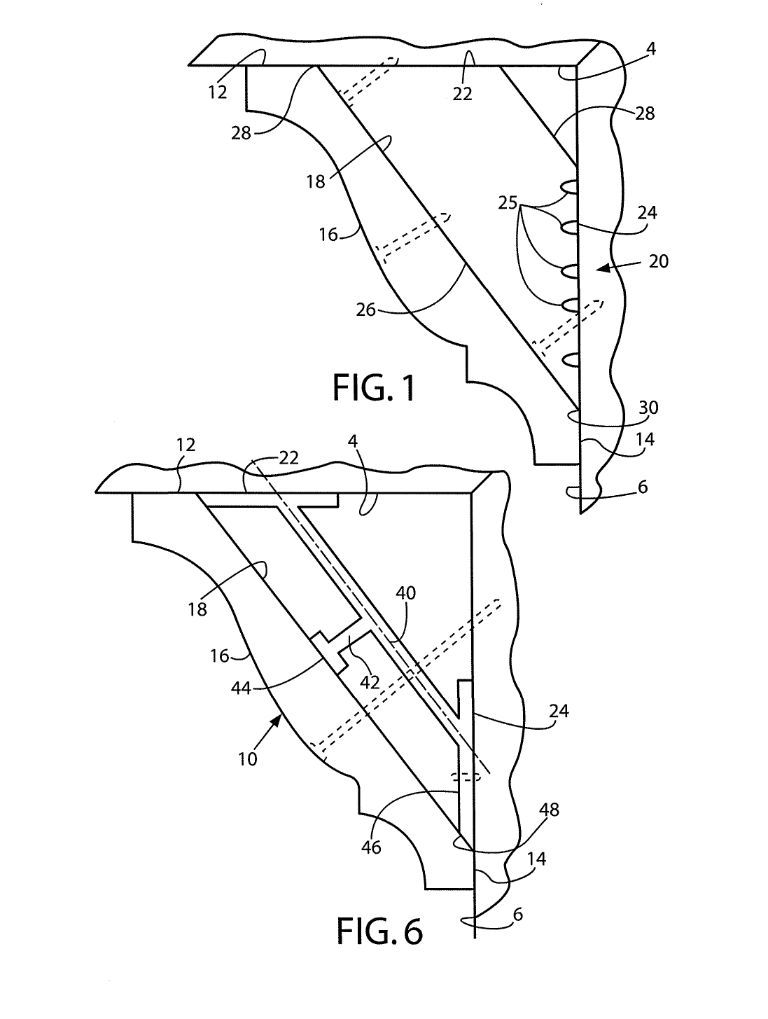

Reference is now made more particularly to FIGS. 1-5, wherein the article of manufacture, generally designated as 20, includes a predetermined length alignable along the junction 8 of the ceiling and wall surfaces, 4 and 6 respectively. The article of manufacture 20 also includes a predetermined cross-sectional shape in a direction transverse to the predetermined length. The predetermined cross-sectional shape has a first surface reference portion 22 extending the predetermined length and abuttingly engageable with the one of the ceiling and wall surfaces, 4 and 6 respectively. There is also a second surface reference portion 24 extending the predetermined length and abuttingly engageable with the opposed one of the ceiling and wall surfaces, 4 and 6 respectively. The second surface reference portion 24 is disposed in a plane being generally perpendicular to a plane of the first surface reference portion 22. The first and second surface reference portions, 22 and 24 respectively, are shown as being substantially smooth surfaces but may be also of any configuration suitable for abutting the respective ceiling surface 4 or wall surface 6 during fastening of the article of manufacture 20. By way of one example only, at least one edge surface, referenced with numeral 24 in FIG. 1, may be provided with at least one groove 25 extending the predetermined length of the article of manufacture 20.

A third surface reference portion 26 is also provided. Furthermore, the third surface reference portion 26 is disposed in a first plane extending at the first angle to the plane of the first surface reference portion 22 and is disposed in a second plane extending at the second angle to the plane of the second surface reference portion 24. In use, the third surface reference portion 26 abuttingly engages the rear substantially smooth surface 18 of the at least one substantially straight length of decorative crown molding 10 secured along the junction 8 of the ceiling and wall surfaces, 4 and 6 respectively.

In accordance with one embodiment of the invention, the third surface reference portion 26 is a substantially smooth uninterrupted surface that abuttingly adjoins each of the first and second surface reference portions 24 and 26 and forms a common front edge 28 with the first surface reference portion 22 and a common front edge 30 with the second surface reference portion 24.

There is also a forth surface 28 oriented toward the ceiling and wall junction 8.

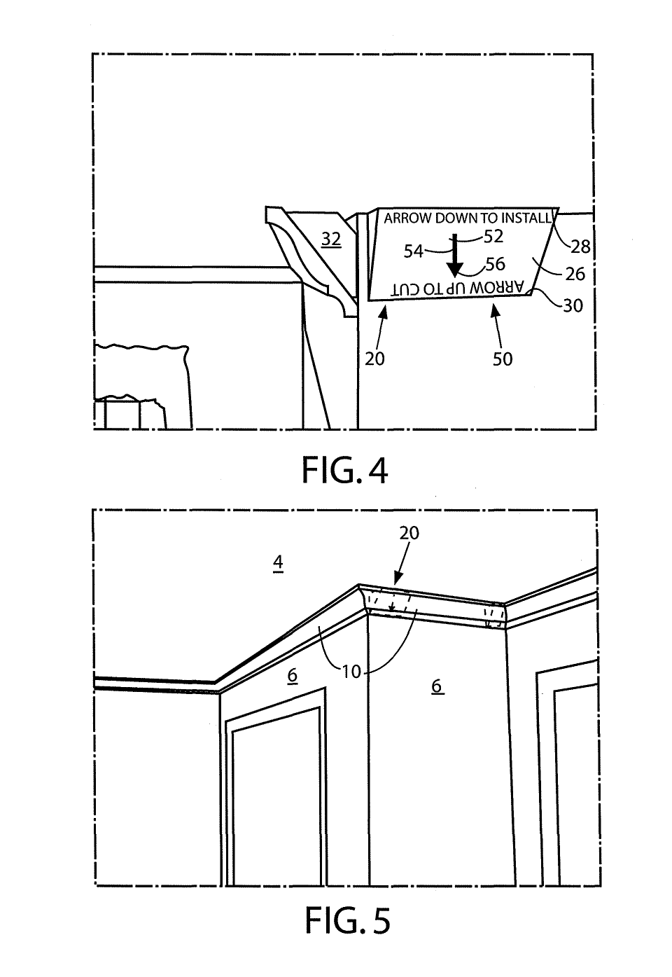

Thus, the article of manufacture 20 of FIG. 1 has a generally trapezoid shape, particularly in use with larger cross-sectional sizes of the decorative crown molding 10 and may have a generally triangular shape for use with smallest cross-sectional sizes of the decorative crown molding 10. It is also contemplated that predetermined cross-sectional shape does not have to be solid and may include a hollow portion 32 extending the predetermined length of the article of manufacture 20, as best shown in FIG. 4. Accordingly, the cross-section of the article of manufacture 20 will have a tubular shape with each of the surfaces 22, 24, 26 and 28 having a predetermined thickness sufficient to prevent deformation and twisting of the article of manufacture 20 during installation and, more particularly, during fastening of the decorative crown molding 10 along the ceiling and wall junction 8.

Now in a particular reference to FIG. 6, the present invention also contemplates that, for the sake of reducing the weight and/or cost of the article 20, the third surface reference portion 26 does not have to be a continuous surface and may be provided as an end surface portion 44 of at least one rib member 42 upstanding on the base 40 that extends the predetermined length of the article of manufacture 20 and that connects first and second edge surfaces, 22 and 24 respectively. Such end surface portion 44 is disposed in the plane extending at the first angle to the first surface reference portion 22 and extending at the second angle to the second surface reference portion 24. The quantity and thickness of each rib member 42 as well as the thickness of the base member 40 are determined so as to prevent deformation and twisting of the article of manufacture 20 during installation and, more particularly, during fastening of the decorative crown molding 10 along the ceiling and wall junction 8. It is contemplated that a single rib member 42 will be sufficient for use with at least the smallest cross-sectional sizes of the decorative crown molding 10. The advantage of the article of manufacture 20 of FIG. 6 is in its ability to be easily and cost effectively manufactured from plastic materials by an extrusion molding process. At least one edge surface, shown as a second edge surface 24, may be extended outwardly from the base member 40 by way of a continuous flange 46. The flange 46 may be extended outwardly and transverse to the predetermined length of the article of manufacture 20 so that its free edge 48 either abuts the rear surface 18 of the decorative crown molding 10, thus providing additional stabilization means or is terminated prior to abutting such rear surface 18. In either configuration, the flange 48 would be suitable for fastening the article of manufacture 20 to the ceiling surface 4 or wall surface 6. Preferably, the thickness of such flange 48 does not exceed 0.13 of an inch so as to enable fastening of the article of manufacture 20 with a conventional staple gun (not shown).

Article of manufacture 20 may be adapted with optional means, generally designated as 50, for orienting position of the first and second edge surfaces, 22 and 24 respectively.

Now in a particular reference to FIGS. 3-4, such position orienting means 50 may include at least one arrow 52 disposed in a position so that it can be viewed when the article of manufacture 20 is used for stabilizing the decorative crown molding 10 prior to fastening operation. The at least one arrow 52 has a generally straight portion 54 disposed in a direction substantially perpendicular to each of the first and second substantially smooth edge surfaces, 22 and 24 respectively, and an identification portion 56 disposed on one end of the generally straight portion 54 adjacent to one of the first and second substantially smooth edge surfaces, 22 and 24 respectively and is shown as having a generally V-shaped member.

When the article 20 is provided with the cross-sectional shape of FIGS. 1-4, such at least one arrow 52 is disposed on such substantially smooth uninterrupted third surface 26.

When the article 20 is provided with the cross-sectional shape of FIG. 6, such at least one arrow 52 may be disposed, for example, on the front surface of the base member 40 and adjacent the second edge surface 24.

Generally, the identification portion 56 of the at least one arrow 52 is pointing in downward direction when the article of manufacture 20 is secured along the ceiling and wall junction 8, as best shown in FIG. 4, and is pointing in an upward direction when the article of manufacture 20 is positioned on the power miter saw 9 for mitering at least one end of the at least one substantially straight length of decorative crown molding 10, as best shown in FIG. 3.

It is also contemplated by the present invention to further provide an optional pair of text indicia 58, 59 adjacent to such at least one arrow 52 containing, for example, such as phrases as “Arrow down for install” and “Arrow up for cut”. Advantageously, the orientation of each text indicia 58, 59 follows the orientation of the article of manufacture 20 during installation of mitering the crown molding 10. More specifically, when the article of manufacture 20 is installed along the ceiling and wall junction 8, the phrase “Arrow down to install” can be normally read while the phrase “Arrow up to cut” is oriented up side down. This orientation reverses when the article of manufacture 20 is positioned for mitering the ends of crown molding 10.

The articles 20 are preferably manufactured from wood and plastic materials and can be attached to the sub-straight with at least one of adhesive and fastener such as screw, nail, or staple.

The article of manufacture 20 may be manufactured in a continuous length, for example in conventional 8, 10, 12 feet or greater with subsequent cutting to a smaller size at the installation site or may be manufactured in such smaller sizes. When the article 20 is manufactured in continuous lengths, the indication means 50 may be incorporated by either a printing process or a stenciling operation. When the article 20 is manufactured in smaller lengths, for example form a plastic material by an injection molding process, the indication means 50 may be economically produced by such injection molding process.

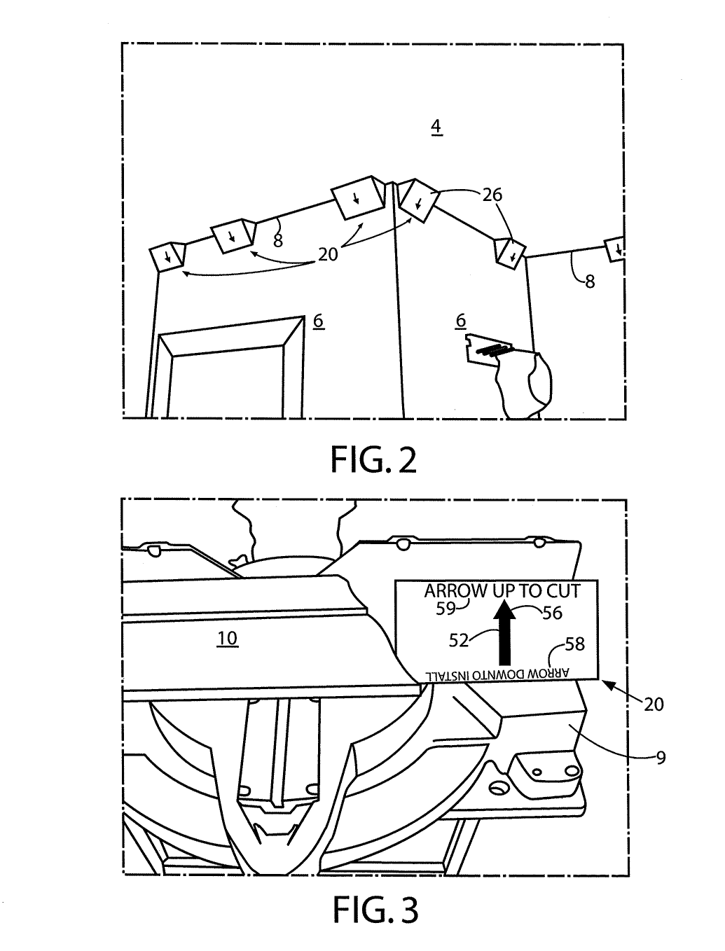

To install the crown molding 10 at the ceiling and wall junction 8, the articles of manufacture 20 are secured along such ceiling and wall junction 8 with the arrow 52 pointing downwardly. The quantity of such articles of manufacture 20 is generally dictated by the length of the ceiling and wall junction 8, although it has been found preferably to secure a pair of articles of manufacture 20 in close proximity to each interior or exterior corner, as best shown in FIG. 2. Either before, during or after securement of articles of manufacture 20 along the ceiling and wall junction 8, another length of the such article of manufacture 20 is employed for stabilizing the crown molding 10 for mitering one or both ends thereof either with a hand saw or a power miter saw 9, as illustrated in FIG. 3 and with the arrow 52 pointing upwardly. Mitered crown molding 10 is then secured to the articles of manufacture 20 or to the ceiling surface 4 or wall surface 6 depending on the type of article of manufacture 20 being used. Advantageously, the present invention eliminates use of any special mitering jigs and/or special tools.

The present invention enables an experienced carpenter, homeowner or “do-it-yourselfer” to stabilize the crown molding during installation along the ceiling and wall junction and during mitering ends of the crown molding, thus assuring that the same angle is produced on the saw as required for installing the crown molding to the ceiling and wall.

Furthermore, articles of manufacture 20 positioned in close proximity to interior and exterior corners of the interior confines, such as a room, facilitate measurements of the crown molding 10 to be cut to size as such crown molding 10 can be stabilized prior to mark a cutting line or point or the measurements may now be made more accurately by placing a tape measure (not shown) or any other suitable measuring devices in engagement with the third surface 26 of the articles of manufacture 20.

Finally, the article of manufacture 20 of the present invention is particularly suitable for use with any conventional crown molding shape designs presently in use and does not require unconventional crown molding shapes.

Although the present invention has been shown in terms of using the crown molding 10 having a smooth rear surface 18, it will be apparent to those skilled in the art, that the present invention may be applied to other crown molding types by varying the configuration of the cross-sectional shape of the article of manufacture 20 to provide proper contact at the rear surface of the particular crown molding shape design.

Furthermore, the arrow 52 may be replaced with any other suitable orientation indication means and text indicia. For example, a simple circle (not shown) may be employed by being position along a suitable side edge.

Thus, the present invention has been described in such full, clear, concise and exact terms as to enable any person skilled in the art to which it pertains to make and use the same. It will be understood that variations, modifications, equivalents and substitutions for components of the specifically described embodiments of the invention may be made by those skilled in the art without departing from the spirit and scope of the invention as set forth in the appended claims.

I claim:

1. In combination with a decorative crown molding having each of a substantially straight length, a pair of edge surface disposed generally perpendicular to one another, a front surface and a rear surface generally extending at a first angle to one of said pair of edge surface and extending at a second angle to an opposed one of said pair of edge surfaces an article of manufacture for stabilizing said decorative crown molding during at least one of installing said decorative crown molding along a junction of a wall surface and a ceiling surface and mitering at least one end of said decorative crown molding, said article of manufacture comprising:
(a) a predetermined length;
(b) a predetermined shape in a direction transverse to said predetermined length, said predetermined shape including:
(i) a first surface reference portion extending said predetermined length and abuttingly engageable with said one of said ceiling and wall surfaces,
(ii) a second surface reference portion extending said predetermined length and abuttingly engageable with an opposed one of said ceiling and wall surfaces, said second surface reference portion disposed in a plane being generally perpendicular to a plane of said first surface reference portion,
(iii) a third surface reference portion extending said predetermined length and disposed in a plane extending at said first angle to said plane of said first surface reference portion and extending at said second angle to said plane of said second surface reference portion; and
(c) means for orienting position of said first and second edge surfaces of said article of manufacture.

2. The article of manufacture, according to claim 1, wherein said first surface reference portion is a first substantially smooth edge surface, wherein said second surface reference portion is a second substantially smooth edge surface and wherein said third surface reference portion is a substantially smooth uninterrupted surface having one longitudinal edge thereof abuttingly engaging a front edge of said first substantially smooth edge surface and having an opposed longitudinal edge thereof abuttingly engaging a front edge of said second substantially smooth edge surface.

3. The apparatus, according to claim 2, wherein said position orienting means includes a plurality of arrows disposed on said substantially smooth third surface and spaced apart a predetermined distance along said predetermined length, each of said plurality of arrows having a generally straight portion disposed in a direction substantially perpendicular to each of said first and second substantially smooth edge surfaces and an identification portion disposed on one end of said generally straight portion of said each of said pluralities of arrows adjacent to one of said first and second substantially smooth edge surfaces.

4. The article of manufacture, according to claim 1, wherein said first surface reference portion is a first substantially smooth edge surface, wherein said second surface reference portion is a second substantially smooth edge surface and wherein said third surface reference portion is disposed on an end of a rib member and has a width thereof being smaller than a distance between front edges of said first and second surface reference portions in a plane generally parallel to said plane of said third surface reference portion.

5. The article of manufacture, according to claim 3, wherein at least one of said first and second surface reference portions includes a flange extending outwardly toward said rear surface of said decorative crown molding and extending said predetermined length of said article of manufacture.

6. The article of manufacture, according to claim 4, wherein a free end of said flange abuts said rear surface of said decorative crown molding.

7. The article of manufacture, according to claim 4, wherein a free end of said flange is terminated prior to abutting said rear surface of said decorative crown molding.

8. A decorative trim system comprising:
(a) at least one substantially straight length of a decorative crown molding having each of a first edge surface abuttingly engageable with one of a ceiling surface and a wall surface, a second edge surface abuttingly engageable with an opposed one of said ceiling and wall surfaces, said second edge surface disposed generally perpendicular to said first edge surface, a front surface and a rear surface, said rear surface extending at a first angle to one of said first and second edge surfaces and extending at a second angle to an opposed one of said first and second edge surfaces; and
(b) at least one crown molding stabilizer secureable along a junction of said ceiling and wall surfaces and including:
(i) a predetermined length alignable along said junction of said wall and ceiling surfaces;
(ii) a predetermined cross-sectional shape in a direction transverse to said predetermined length, said predetermined cross-sectional shape including:
a. a first surface reference portion extending said predetermined length and abuttingly engageable with said one of said ceiling and wall surfaces,
b. a second surface reference portion extending said predetermined length and abuttingly engageable with said opposed one of said ceiling and wall surfaces, said second surface reference portion disposed in a plane being generally perpendicular to a plane of said first surface reference portion,
c. a third surface reference portion extending said predetermined length and abuttingly adjoining each of said first and second surface reference portions, said third surface reference portion disposed at said first angle to said first surface reference portion and disposed at said second angle to said second surface reference portion, said third surface reference portion abuttingly engageable with said rear surface of said at least one substantially straight length of decorative crown molding secured along said junction of said ceiling and wall surfaces, and
(iii) means for orienting position of said first and second edge surfaces of said at least one substantially straight length of decorative crown molding.

9. The decorative trim system, according to claim 8, wherein said first surface reference portion is a first substantially smooth edge surface, wherein said second surface reference portion is a second substantially smooth edge surface and wherein said third surface reference portion is a substantially smooth uninterrupted front surface.

10. The decorative trim system, according to claim 9, wherein said position orienting means includes at least one arrow disposed on said substantially smooth uninterrupted front surface and having a generally straight portion disposed in a direction substantially perpendicular to each of said first and second substantially smooth edge surfaces and an identification portion disposed on one end of said generally straight portion adjacent to one of said first and second substantially smooth edge surfaces.

11. The decorative trim system, according to claim 10, wherein said identification portion of said at least one arrow is pointing in one of upward and downward directions when said least one crown molding support is secured along said junction of said ceiling and wall surfaces and wherein said identification portion of said at least one arrow is pointing in an opposed one of said upward and downward directions when said least one crown molding support is positioned for mitering at least one end of said at least one substantially straight length of decorative crown molding.

12. The decorative trim system, according to claim 10, wherein said position orienting means further includes at least one pair of text indicia disposed adjacent said at least one arrow.

13. The decorative trim system, according to claim 10, wherein one of said at least one pair of text indicia indicates orientation of said at least one crown molding stabilizer for fastening to said one of said ceiling and wall surfaces and wherein an opposed one of said at least one pair of text indicia indicates orientation of said at least one crown molding stabilizer for mitering at least one end of said at least one substantially straight length of decorative crown molding.

14. A decorative trim system comprising:
(a) at least one substantially straight length of decorative crown molding having each of a pair of edge surface disposed generally perpendicular to one another, a front surface and a rear surface extending at a first angle to one of said pair of edge surface and extending at a second angle to an opposed one of said pair of edge surfaces; and
(b) at least one crown molding stabilizer having each of a predetermined length and a predetermined shape in a direction transverse to said predetermined length, said predetermined cross-sectional shape including:
(i) a first substantially smooth edge surface extending said predetermined length,
(ii) a second substantially smooth edge surface extending said predetermined length and disposed generally perpendicular to said first substantially smooth edge surface,
(iii) a substantially smooth uninterrupted front surface extending said predetermined length and having each longitudinal edge thereof abuttingly adjoining respective longitudinal edge of each of said first and second substantially smooth edge surfaces, said substantially smooth uninterrupted front surface extending at said first angle to said first substantially smooth edge surface and extending at said second angle to said second substantially smooth edge surface,
(iv) a rear surface extending said predetermined length and, and
(v) at least one arrow disposed on said substantially smooth front surface and having a generally straight portion thereof disposed in a direction substantially perpendicular to each of said first and second substantially smooth edge surfaces and an identification portion thereof disposed on one end of said generally straight portion adjacent to one of said first and second substantially smooth edge surfaces,
(c) whereby said at least one crown molding support is secured along a junction of wall surface and ceiling surface so that said identification portion of said at least one arrow is pointing in one of a downward and upward directions;
(d) whereby said rear surface of said at least one substantially straight length of decorative crown molding is positioned in abutting engagement with said substantially smooth front surface of said at least one crown molding support so that said at least one substantially straight length of decorative crown molding can be secured along said junction of said wall surface and said ceiling surface; and
(e) whereby said at least one crown molding support can be positioned with said identification portion of said at least one arrow is pointing in an opposed one of said downward and upward directions for mitering at least one end of said at least one substantially straight length of decorative crown molding.
